(19) United States
(12) Patent Application Publication
(10) Pub. No.: US 2005/0187374 A1
(43) Pub. Date: Aug. 25, 2005

(54) Polyester synthesis with enhanced titanium catalyst composition

(76) Inventors: Bin Chen, Wayne, PA (US); Conor M. Dowling, Blue Bell, PA (US); Sri R. Seshadri, Holland, PA (US)

Correspondence Address: ARKEMA INC.;PATENT DEPARTMENT - 26TH FLOOR, 2000 MARKET STREET, PHILADELPHIA, PA, 19103-3222, US

(21) Appl. No.: 10/783,485

(22) Filed: Feb. 20, 2004

(51) Int. Cl. C08G 63/78

(52) U.S. Cl. 528/275

(57) ABSTRACT

A catalyst composition for preparing polyesters comprises a titanium compound and one or more catalyst enhancers. The titanium compound may be either a titanyl compound of the formula XₘTiOYₒ or a titanium salt of the formula XₘTiYₒ, where each X is independently selected from the group consisting of H, Li, Na, K, Rb, Cs, Be, Mg, Ca, Sr, Ba and ammonium; m=0, 1 or 2; Y is a ligand of the formula CₐH_{b}O_{c}, wherein a=1 to 30, b=0 to 60, and c=1 to 10; and o=2, 3, or 4. The catalyst enhancer may be selected from either or both of two classes: 1) compounds selected from the group consisting of oxalate and C1-C26 carboxylate salts of Li, Na, K, Rb, Cs, Be, Ca, Mg, Sr, and Ba; and 2) compounds selected from the group consisting of soluble compounds of Al, Co, Zn, and Sn.

### FIELD OF THE INVENTION

This invention relates to catalysts for esterification and transesterification. More specifically, it relates to titanium-containing catalyst compositions and methods of using them to prepare esters such as polyesters.

### BACKGROUND OF THE INVENTION

Esterification and transesterification reactions are important industrial processes, typically performed in the presence of a catalyst. One particularly important industrial process employing these reactions is the formation of polyesters, for example polyethylene terephthalate (PET), which is used for making a variety of products. One especially large use of PET is for making bottles, such as are used for packaging sodas and other beverages.

For the preparation of polyesters of relatively high molecular weight, for example those used for making beverage bottles, a typical process involves first esterifying TPA (and typically some amount of isophthalic acid) with EG in the presence of a catalyst to form oligomers. The oligomers are then polycondensed to form the final PET. As used herein, the term terms “PET” and “polyethylene terephthalate” will be understood to include polyesters having other diacid component(s) in addition to TPA and/or other diol component(s) in addition to EG.

Polycondensation reactions to make PET are typically performed in two steps: a melt polycondensation, during which a product having an intermediate molecular weight (intrinsic viscosity (IV) of about 0.6 dL/g) is produced, and a subsequent solid state polycondensation in which the product of the melt polycondensation is heated at a temperature below its melting point to produce a final product of higher molecular weight (IV typically between about 0.7 and 1.0 dL/g). Both polycondensation reactions require an extremely long period of time, which is significantly reduced by use of a suitable catalyst. Various types of catalysts are used for this purpose. For example, antimony trioxide, antimony triacetate and antimony trisglycolate are commonly used as polycondensation catalysts for both the melt and solid state reactions. However, relatively large amounts of such antimony catalysts are required in order to achieve sufficient activity, which is at cross purposes with a general trend in the industry to reduce the amount of antimony and other heavy metals in consumer and other products, for environmental reasons.

Organotitanium compounds, such as titanium alkoxides, have been disclosed as catalysts for esterification processes. However, esterification reactions produce water, and many organotitanium compounds are hydrolytically unstable. As a result, they tend to be converted to insoluble titanium compounds, resulting in reduced catalyst activity and the formation of haze when used for making polyesters. More recently, the use of titanyl oxalate compounds such as potassium titanyl oxalate as catalysts has been disclosed for preparing polyesters. These provide better hydrolytic stability than other titanium compounds.

Some titanium based catalysts, including titanyl oxalate compounds, have shown very high activity as melt polycondensation catalysts, but the resulting polyesters are typically of a yellowish color, which limits their applicability. As a result of the above-mentioned limitations, considerable work has been directed towards the development of modified titanium catalysts in an effort to avoid these problems. Combinations of Ti compounds with various additives or cocatalysts have been disclosed in the art, but catalyst performance, especially relating to solid state polycondensation of polyesters, has been less than promising.

### SUMMARY OF THE INVENTION

In one aspect, the invention provides a catalyst composition comprising:
(a) one or both of a titanyl compound of the formula XmTiOYₒ and an organic titanium salt of the formula XmTiYₒ; and
(b) a catalyst enhancer comprising a compound selected from the group consisting of soluble compounds of Al, Co, Zn, and Sn;
   wherein X is selected from the group consisting of: H, Li, Na, K, Rb, Cs, Be, Ca, Mg, Sr, Ba, and ammonium; m=0, 1 or 2; Y is a ligand of the formula CₐH_{b}O_{c} wherein a=1 to 30, b=0 to 60, and c=1 to 10; and o=2, 3, or 4.

In another aspect, the invention provides a method of making an ester, the method comprising performing an ester-forming condensation reaction on a feedstock to produce a condensation product, the reaction comprising heating a mixture of the feedstock and a catalyst composition comprising:
(a) one or both of a titanyl compound of the formula XmTiOYₒ and an organic titanium salt of the formula XmTiYₒ; and
(b) a catalyst enhancer comprising a compound selected from the group consisting of soluble compounds of Al, Co, Zn, and Sn;
   wherein X is selected from the group consisting of: H, Li, Na, K, Rb, Cs, Be, Ca, Mg, Sr, Ba, and ammonium; m=0, 1 or 2; Y is a ligand of the formula CₐH_{b}O_{c} wherein a=1 to 30, b=0 to 60, and c=1 to 10; and o=2, 3, or 4.

In yet another aspect, the invention provides an ester made by a method comprising performing an ester-forming condensation reaction on a feedstock, the reaction comprising heating a mixture of the feedstock and a catalyst composition comprising:
(a) one or both of a titanyl compound of the formula XmTiOYₒ and an organic titanium salt of the formula XmTiYₒ; and
(b) a catalyst enhancer comprising a compound selected from the group consisting of soluble compounds of Al, Co, Zn, and Sn;
   wherein X is selected from the group consisting of: H, Li, Na, K, Rb, Cs, Be, Ca, Mg, Sr, Ba, and ammonium; m=0, 1 or 2; Y is a ligand of the formula CₐH_{b}O_{c} wherein a=1 to 30, b=0 to 60, and c=1 to 10; and o=2, 3, or 4.

In still another aspect, the invention provides a method of making an ester, the method comprising performing an ester-forming condensation reaction on a feedstock consisting essentially of PET to produce a condensation product comprising PET of higher molecular weight than the PET in the feedstock, the reaction comprising heating, at a temperature below a melting point of the feedstock, a mixture of the feedstock and a catalyst composition comprising:
(a) one or both of a titanyl compound of the formula XmTiOYₒ and an organic titanium salt of the formula XmTiYₒ; and
(b) a catalyst enhancer comprising a compound selected from the group consisting of oxalate or C1-C26 carboxylate salts of Li, Na, K, Rb, Cs, Be, Ca, Mg, Sr, and Ba, wherein the catalyst enhancer comprises an oxalate salt if the catalyst composition comprises XmTiYₒ;
   wherein X is selected from the group consisting of: H, Li, Na, K, Rb, Cs, Be, Ca, Mg, Sr, Ba, and ammonium; m=0, 1 or 2; Y is a ligand of the formula CₐH_{b}O_{c} wherein a=1 to 30, b=0 to 60, and c=1 to 10; and o=2, 3, or 4.

In a further aspect, the invention provides an ester made by a method comprising performing an ester-forming condensation reaction on a feedstock consisting essentially of PET to produce a condensation product comprising PET of higher molecular weight than the PET in the feedstock, the reaction comprising heating, at a temperature below a melting point of the feedstock, a mixture of the feedstock and a catalyst composition comprising:
(a) one or both of a titanyl compound of the formula XmTiOYo and an organic titanium salt of the formula XmTiYo; and
(b) a catalyst enhancer comprising a compound selected from the group consisting of oxalate or C1-C26 carboxylate salts of Li, Na, K, Rb, Cs, Be, Ca, Mg, Sr, and Ba, wherein the catalyst enhancer comprises an oxalate salt if the catalyst composition comprises XmTiYo;
   wherein X is selected from the group consisting of: H, Li, Na, K, Rb, Cs, Be, Ca, Mg, Sr, Ba, and ammonium; m=0, 1 or 2; Y is a ligand of the formula CaHbOc wherein a=1 to 30, b=0 to 60, and c=1 to 10; and o=2, 3, or 4.

### DETAILED DESCRIPTION OF THE INVENTION

Titanium-containing catalyst compositions incorporating either or both of two classes of catalyst enhancer have been found to provide remarkable catalytic effectiveness for esterification and melt polycondensation reactions, such as those used in making polyesters. They show especially high performance in solid state polycondensation reactions for making polyesters. In one embodiment of the invention, the catalyst composition comprises both classes of catalyst enhancer. In the following description of catalyst compositions and the components thereof, it will be understood by the person of ordinary skill in the art that, although not explicitly shown, there may be varying degrees of water of hydration in any given component. For example, some of the titanyl compounds and some of the metal salts are typically most readily available in hydrated form. Catalyst components either with or without water of hydration are suitable for use according to the invention.

The catalyst compositions comprise either or both of two types of titanium compound: titanyl compounds and organic titanium salts. Titanyl compounds useful for making catalysts according to the present invention are of the formula XₘTiOYₒ, where each X is independently selected from the group consisting of H, Li, Na, K, Rb, Cs, Be, Mg, Ca, Sr, Ba and ammonium, and m=0, 1 or 2, Y is a ligand of the formula CₐH_{b}O_{c}, wherein a, b, and c are integers from 1 to 30, 0 to 60, and 1 to 10, respectively, and o=2, 3, or 4. Typically, X=H, Li, Na, K, Ca, Cs or ammonium. Nonlimiting examples of Y include RO— and R—CO₂—, where R is an alkyl, aryl, or aralkyl group, or an alkyl, aryl, or aralkyl group additionally comprising one or more hydroxyl, carboxyl, or ether moieties. Y may also be acetylacetonate or an analogous dionate. Particular suitable examples of Y include, for example, acetylacetonate; i-propoxide; butoxide; and 2,2,6,6-tetramethyl-3,5-heptanedionate. In one embodiment, Y is oxalate and o=2. Suitable exemplary compounds where m=0 include titanyl bis(2,2,6,6-tetramethyl-3,5-heptanedionate) and titanyl bis(acetylacetonate). For m=1, suitable compounds include calcium titanyl oxalate and magnesium titanyl oxalate, and for m=2, potassium titanyl oxalate and sodium titanyl oxalate. Other exemplary suitable titanyl compounds include ones analogous to the foregoing list of titanyl oxalates, where one or both of the oxalates (and a metal associated with it) is replaced by one or more other Y groups as defined above.

Organic titanium salts suitable for use according to the invention include compounds of the formula XₘTiYₒ wherein X, m, Y, and o are as defied above. Suitable exemplary values of Y are as listed above, and more particularly include acetylacetonate, i-propoxide, and 2,2,6,6-tetramethyl-3,5-heptanedionate. When only XₘTiYₒ is used as the titanium-containing portion of the catalyst composition, it is particularly effective to include an oxalate compound in the enhancer, or combination of enhancers.

Titanyl compounds and/or titanium salts as described above are typically employed in the catalyst compositions in amounts to provide between about 0. I ppm and about 100 ppm, calculated by weight of titanium in the condensation product. More typically, between about 1 ppm and about 30 ppm is used, and most typically between about 5 ppm and 30 ppm.

The first class of catalyst enhancers for use in combination with either a titanyl compound or an organic titanium salt comprises compounds selected from the group consisting of oxalate and C1-C26 carboxylate salts of Li, Na, K, Rb, Cs, Be, Ca, Mg, Sr, and Ba. Compounds from the first class of catalyst enhancers are typically added in an amount such that the level of metal (by weight) in the condensation product is at least 0.1 ppm, typically at least 5 ppm, and more typically at least about 10 ppm. The level of metal is at most 200 ppm, typically at most 100 ppm, and more typically at most 40 ppm. In one embodiment of the invention, a catalyst enhancer of the first class comprises both an oxalate and a carboxylate salt.

Suitable C1-C26 carboxylate salts of Li, Na, K, Rb, Cs, Be, Ca, Mg, Sr, and Ba are to be understood to include di- and tricarboxylic acid salts. Nonlimiting examples of suitable C1-C26 carboxylate salts include the sodium and potassium salts of the following acids: acetic, propionic, citric, butyric, formic, fumaric, malonic, succinic, glutaric, adipic, maleic, and benzoic. Typically used salts according to the invention are potassium acetate and potassium benzoate.

The second class of catalyst enhancers comprises compounds selected from the group consisting of soluble compounds of Al, Co, Zn, and Sn. As used herein, the term “soluble compound” as applied to a component of a catalyst composition means a compound that dissolves, with or without concurrent chemical reaction, into the reaction mixture that is being catalyzed. Suitable soluble compounds for use in making catalyst compositions according to the invention are detailed below. Suitable soluble zinc compounds include, as nonlimiting examples, zinc acetate, zinc carbonate, zinc chloride, zinc citrate, and zinc oxalate.

Suitable soluble aluminum compounds include, as nonlimiting examples, aluminum alcoholates; aluminum carboxylates such as aluminum lactate and aluminum acetate; basic aluminum acetate; inorganic aluminum salts such as aluminum chloride, aluminum hydroxide, aluminum hydroxychloride, and combinations of these.

Suitable soluble cobalt compounds include, as nonlimiting examples, cobalt carboxylates such as diacetate tetrahydrate.

Suitable soluble tin compounds include, as nonlimiting examples, dibutyl tin oxide, dibutyl tin diacetate, monobutyl tin oxide, butyl tin chloride dihydroxide, monobutyl tin tris(ethylhexanoate), stannous oxalate, and stannous bis(2-ethylhexonate).

Either the first or second class of enhancer defined above may further comprise a soluble antimony or soluble germanium compound, which may provide additional enhancement of catalyst effectiveness. Suitable soluble antimony compounds include, as nonlimiting examples, SbCl₃, Sb₂O₃, Sb(CH₃COO)₃, and Sb₂(OCH₂CH₂O)₃. Suitable soluble germanium compounds include, as nonlimiting examples, GeO₂, Ge(OC₂H₅)₄, Ge(OCH(CH₃)₂)₄, and Ge(OCH₃)₄. Preferred is GeO₂.

Zinc, aluminum, cobalt, tin, antimony, and germanium compounds are typically employed in amounts between about 0.1 ppm and about 300 ppm, calculated by weight of the metal in the condensation product. More typically, between about 1 ppm and about 100 ppm is used, and most typically between about 5 ppm and 50 ppm.

In one embodiment of the invention, the catalyst composition may also comprise a soluble phosphorus compound, in addition to the titanium compound and the catalyst enhancer, for purposes of enhancing stability, including thermal and color stability, of the product. When a phosphorus compound is used, it is preferred that the catalyst enhancer also comprise a soluble cobalt compound such as has been described above. Suitable soluble phosphorus compounds for use according to the invention include, as nonlimiting examples, phosphoric acid, phosphorous acid, phosphonic acids, phosphinic acids, and esters and mixtures of any of these. When a phosphorus compound is used, it is typically employed in amounts between about 0.1 ppm and about 300 ppm, calculated by weight as phosphorus in the condensation product. More typically, between about 1 ppm and about 100 ppm is used, and most typically between about 5 ppm and 50 ppm.

Catalyst compositions comprising at least one of the above-mentioned titanium compounds and catalyst enhancers may generate less diethylene glycol (DEG) in the product PET. Catalytic compositions according to the invention may also produce PET having a slow thermal crystallization rate, which may reduce haze and/or shorten cooling cycle time during molding.

The components of the catalyst compositions of the present invention may be added to the ingredients for making polyester in any of a number of sequences, or in many cases they can all be added simultaneously if desired. Typically, one or more of the components is first dissolved in a solvent that is compatible with polyester forming reactants, or preferable in one of the reactants itself, such as ethylene glycol. The catalyst component is then added to the other reactants, and the esterification and/or polycondensation reaction is performed according to methods and practices well known in the art.

The synergistic performance of the catalyst enhancer in combination with one or more titanium compounds for polycondensation reactions for the production of PET resin is shown by the following examples.

### EXAMPLES

In the following examples, polycondensation rate is indicated by the rate at which intrinsic viscosity (IV) of the polymer increases during the reaction. The solution intrinsic viscosity (IV) was measured according to the method of ASTM D 4603.

### General Experimental Procedure

Catalyst evaluation was performed with a 316 stainless steel, 2 L reactor, fitted with a ball valve at the bottom of the reactor. The vessel was equipped with 3 inlet ports, one outlet port, one thermowell port and one pressure transducer port, and was vertically stirred by an electric motor with amperage monitoring. The laboratory experimental procedures were all conducted using 4.0 mole of bis(2-hydroxyethyl)terephthalate (BHET) in a formulation such as would typically be used for making bottle grade PET in an autoclave reactor. The experimental catalysts were predissolved in ethylene glycol and added after the BHET melted.

BHET and catalyst were added to the reactor and the contents blanketed with nitrogen. The mixtures were heated under reduced pressure with constant stirring. The ethylene glycol (EG) produced during the polycondensation was trapped and removed. The polycondensation was performed at 280° C., under a pressure of typically around 1 torr. The reaction was terminated when the stirrer torque reached a level, indicated by amperage to the stirrer motor, typical for a polymer of IV ˜0.6. The molten state polymer under nitrogen (containing less than 2 ppm of oxygen) blanket was discharged from the bottom ball valve and quenched into a bucket filled with cold water. Pellets ¼″ in diameter and 1/16″ in thickness (for color measurement) were made by filling a press molder with the molten polymer and chilling immediately in cold water.

The examples shown in Table 1 show the effectiveness of using catalyst enhancers according to the invention in combination with potassium titanyl oxalate. In some cases the catalysts were further augmented with antimony and phosphorus compounds. Melt polycondensation started with BHET as described previously. Additionally, in some of the examples, phosphoric acid and cobalt acetate were added before the titanium compound. Melt polycondensation was terminated with IV reached 0.620 dL/g. Molten PET was discharged, quenched, and then pelletized. The samples were further sieved to achieve uniform particle size of about 119 pellets per gram for solid-state polycondensation. This is particularly important because the size of PET pellets has an effect on the diffusion of by-products such as water and ethylene glycol, and hence of the rate of solid state polycondensation, which is an equilibrium-driven process. PET pellets were placed into a metal mesh basket, and the basket was suspended in a resin kettle. A 200 cc/min flow of nitrogen was introduced from the top of the basket. The pellets were dried at 120° C. for 30 minutes, and the temperature was then slowly ramped to 210° C., and maintained there for 7 to 16 hours. The solid state polycondensation rate constant (k) was calculated according to Equation 2, shown below.

Values of the solid state polycondensation rate constant k shown in the following tables were determined by applying Equations 1 and 2 below, as is known in the art,
k=(MW−MWₒ)/t^{1/2} Equation 1
MW=(5882 IV)^{1.20} Equation 2
where k is the solid-state polycondensation rate constant, MW is average molecular weight at time t, MWₒ is initial molecular weight of a precursor, t is time in minutes of solid-state reaction at a given temperature, and IV is intrinsic viscosity (dL/g).

The results from using five sets of catalysts, labeled Series 1-5, are reported below in Table 1.

TABLE 1

| | | | | | | | | | Melt | | | Solid State | | | |
|---|---|---|---|---|---|---|---|---|---|---|---|---|---|---|---|
| | | | | | | | | | Polymerization | | | Polymerization | | | |
| | | | | | | | | | Time | IV | Mₒ | Time | IV | M | K |
| | Ti | K | Sb | Li | Al | P | Co | Mg | (min) | (dL/g) | g/mol | (hrs) | (dL/g) | g/mol | gmol⁻¹ min^{-0.5} |
| Series 1 | | | | | | | | | | | | | | | |
| 1 | | | 240 | | | | | | 112 | 0.623 | 19548 | 16 | 0.942 | 32158 | 407.0 |
| 2 | 6 | 9.8 | | | | | | | 125 | 0.633 | 19926 | 16 | 0.930 | 31666 | 378.9 |
| 3 | 6 | 30 | 25 | | | | | | 104 | 0.619 | 19397 | 16 | 0.973 | 33437 | 453.1 |
| 4 | 6 | 9.8 | | | | 20 | | | 160 | 0.618 | 19359 | 16 | 0.697 | 22376 | 97.4 |
| 5 | 6 | 9.8 | | | | 20 | 31 | | 138 | 0.620 | 19435 | 16 | 0.877 | 29506 | 325.0 |
| 6 | 6 | 9.8 | | | | 20 | 61 | | 107 | 0.620 | 19435 | 16 | 1.000 | 34557 | 488.1 |
| 7 | 6 | 9.8 | | | | 20 | | 19 | 129 | 0.628 | 19737 | 16 | 0.859 | 28778 | 291.8 |
| 8 | 6 | 30 | 25 | | | 10 | 30 | | 97 | 0.612 | 19133 | 16 | 0.928 | 31584 | 401.8 |
| Series 2 | | | | | | | | | | | | | | | |
| 1 | 6 | 9.8 | 25 | 0 | | 10 | 30 | | 99 | 0.620 | 19435 | 16 | 0.917 | 31133 | 377.6 |
| 2 | 6 | 9.8 | 25 | 1 | | 10 | 30 | | 93 | 0.615 | 19246 | 16 | 0.914 | 31011 | 379.7 |
| 3 | 6 | 9.8 | 25 | 2 | | 10 | 30 | | 97 | 0.616 | 19284 | 16 | 0.948 | 32405 | 423.5 |
| 4 | 6 | 9.8 | 25 | 3 | | 10 | 30 | | 107 | 0.609 | 19020 | 16 | 0.920 | 31256 | 394.9 |
| 5 | 6 | 9.8 | 25 | 4 | | 10 | 30 | | 96 | 0.616 | 19284 | 16 | 0.937 | 31953 | 408.9 |
| 6 | 6 | 9.8 | 25 | 6 | | 10 | 30 | | 103 | 0.630 | 19813 | 16 | 0.964 | 33065 | 427.7 |
| 7 | 6 | 9.8 | 25 | 9 | | 10 | 30 | | 97 | 0.619 | 19397 | 16 | 0.980 | 33726 | 462.5 |
| Series 3 | | | | | | | | | | | | | | | |
| 1 | 6 | 9.8 | 25 | | | 10 | 30 | | 99 | 0.620 | 19435 | 16 | 0.917 | 31133 | 377.6 |
| 2 | 6 | 21 | 25 | | | 10 | 30 | | 95 | 0.602 | 18757 | 16 | 0.929 | 31625 | 415.3 |
| 3 | 6 | 30 | 25 | | | 10 | 30 | | 97 | 0.612 | 19133 | 16 | 0.928 | 31584 | 401.8 |
| 4 | 6 | 60 | 25 | | | 10 | 30 | | 103 | 0.614 | 19208 | 16 | 0.928 | 31584 | 399.4 |
| Series 4 | | | | | | | | | | | | | | | |
| 1 | 6 | 30 | | | 20 | 10 | 30 | | 90 | 0.611 | 19095 | 16 | 1.006 | 34807 | 507.1 |
| 2 | 4 | 30 | | | 20 | 10 | 30 | | 95 | 0.609 | 19020 | 16 | 0.927 | 31543 | 404.2 |
| Series 5 | | | | | | | | | | | | | | | |
| 1 | 6 | 30 | 120 | | | 10 | 30 | | 88 | 0.613 | 19171 | 16 | 0.982 | 33809 | 472.5 |
| 2 | 6 | 9.8 | 120 | | | 10 | 30 | | 89 | 0.619 | 19397 | 16 | 0.972 | 33395 | 451.8 |

For each catalyst composition, the headings under each component indicate parts per million of that material (as the element) in the product. The metals were provided by the following materials: potassium titanyl oxalate, potassium oxalate, antimony oxide, lithium oxalate, aluminum lactate, cobalt diacetate tetrahydrate, and magnesium acetate. Phosphorus was provided by phosphoric acid.

Comparison of Series 1 examples 1-3 shows the benefit to polymerization rate of incorporating potassium oxalate and antimony in the titanium-containing catalyst.

Comparison of Series 1 examples 4-6 shows the benefit to polymerization rate of incorporating cobalt in the titanium-containing catalyst.

Comparison of Series 1 examples 4 and 7 shows the benefit to polymerization rate of incorporating magnesium in the titanium-containing catalyst.

Series 2 shows the benefit to polymerization rate of incorporating lithium in the titanium-containing catalyst.

Series 3 shows the benefit to polymerization rate of incorporating potassium in the titanium-containing catalyst. In these examples, potassium levels in the range of about 10 to about 40 ppm, more specifically about 25 to about 35 ppm, worked especially well.

Series 4 and 5, in light of the results of Series 1 example 8, show the benefit to polymerization rate of incorporating aluminum and antimony, respectively, in the titanium-containing catalyst.

Table 2, shown below, indicates the rate at which PET samples made with the indicated catalyst formulations degraded in an extruder at 300° C., as measured by loss of molecular weight as a function of time. The metals were provided by the following materials: potassium titanyl oxalate, potassium oxalate, and antimony oxide.

TABLE 2

| | | | | Degradation |
|---|---|---|---|---|
| | Ti | K | Sb | Rate* |
| 1 | 4 | 34.8 | 50 | 0.47 |
| 2 | 4 | 12.2 | 50 | 0.47 |
| 3 | 4 | 6.5 | 50 | 0.58 |

*[−d(log mv)/dt]

In the expression [−d(log mv)/dt], mv indicates the voltage needed to maintain a set rpm on a melt viscometer in which the viscosity of each of the PET samples was measured, and t is the time at 300° C. The results indicate that the addition of potassium oxalate to the catalyst improved melt stability of the resulting PET.

Table 3, shown below, shows the amount of diethylene glycol produced in polycondensations using catalysts according to the invention. The metals were provided by the following materials: potassium titanyl oxalate, potassium oxalate, and antimony oxide (except where noted).

TABLE 3

| | | | | Wt. % |
|---|---|---|---|---|
| | Ti | K | Sb | DEG* |
| 1 | 5 | 20 | 10 | 0.37 |
| 2 | 1 | 20 | 60 | 0.54 |
| 3 | 1 | 160 | 10 | 0.38 |
| 4 | 5 | 160 | 60 | 0.44 |
| 5 | 3 | 10 | 38 | 0.57 |
| 6 | | | **180 | 1.73 |
| 7 | | | 180 | 1.83 |

*DEG—diethylene glycol
**Sb₂(—OCH₂—CH₂O—)₃ was used

The results of Table 3 show a noticeable reduction in the amount of diethylene glycol produced when potassium oxalate and antimony were combined with potassium titanyl oxalate, compared to the results obtained using only antimony as a catalyst.

As the results in Tables 1-3 indicate, the rates of 1) melt polycondensation and 2) solid state polycondensation to produce PET can be increased by the use of catalyst compositions according to the invention. Further, a reduction in the formation of certain undesirable side products such as diethylene glycol may be provided by use of such catalyst compositions, and PET having a lower rate of thermal degradation may also be prepared with these compositions.

Although the preparation of polyesters by use of the catalysts of this invention have been exemplified in detail in the foregoing description of the invention, it is to be understood that catalysts according to the invention are useful for other esterification reactions, and the claims are to be construed with that understanding. More generally, although the invention is illustrated and described herein with reference to specific embodiments, the invention is not intended to be limited to the details shown. Rather, it is intended that the scope of the claims that follow includes various modifications that may be made in the details while nevertheless achieving the effects of this invention.

1. A catalyst composition comprising:
(a) one or both of a titanyl compound of the formula XₘTiOYₒ and an organic titanium salt of the formula XₘTiYₒ; and
(b) a catalyst enhancer comprising a compound selected from the group consisting of soluble compounds of Al, Co, Zn, and Sn;
wherein X is selected from the group consisting of: H, Li, Na, K, Rb, Cs, Be, Ca, Mg, Sr, Ba, and ammonium; m=0, 1 or 2; Y is a ligand of the formula CₐH_{b}O_{c} wherein a=1 to 30, b=0 to 60, and c=1 to 10; and o=2, 3, or 4.

2. The catalyst composition of claim 1, wherein one or both of the catalyst and the enhancer comprises an oxalate moiety.

3. The catalyst composition of claim 1, wherein component (a) comprises XₘTiO(C₂O₄)₂.

4. The catalyst composition of claim 1, wherein in component (b) comprises a soluble Al compound.

5. The catalyst composition of claim 1, further comprising a soluble antimony compound.

6. The catalyst composition of claim 1, wherein the catalyst enhancer further comprises a compound selected from the group consisting of oxalate or C₁-C₂₆ carboxylate salts of Li, Na, K, Rb, Cs, Be, Ca, Mg, Sr, and Ba, wherein the catalyst enhancer comprises an oxalate salt if the catalyst composition comprises XₘTiYₒ.

7. The catalyst composition of claim 1, wherein said one or both of a titanyl compound of the formula XₘTiOYₒ and an organic titanium salt of the formula XₘTiYₒ comprises potassium titanyl oxalate, and the catalyst enhancer comprises a soluble aluminum compound and potassium oxalate.

8. A method of making an ester, the method comprising performing an ester-forming condensation reaction on a feedstock to produce a condensation product, the reaction comprising heating a mixture of the feedstock and a catalyst composition comprising:
(a) one or both of a titanyl compound of the formula XₘTiOYₒ and an organic titanium salt of the formula XₘTiYₒ; and
(b) a catalyst enhancer comprising a compound selected from the group consisting of soluble compounds of Al, Co, Zn, and Sn;
wherein X is selected from the group consisting of: H, Li, Na, K, Rb, Cs, Be, Ca, Mg, Sr, Ba, and ammonium; m=0, 1 or 2; Y is a ligand of the formula CₐH_{b}O_{c} wherein a=1 to 30, b=0 to 60, and c=1 to 10; and o=2, 3, or 4.

9. The method of claim 8, wherein said one or both of a titanyl compound of the formula XₘTiOYₒ and an organic titanium salt of the formula XₘTiYₒ comprises XₘTiO(C₂O₄)₂.

10. The method of claim 8, the catalyst composition further comprising a soluble antimony compound.

11. The method of claim 8, wherein said one or both of a titanyl compound of the formula XₘTiOYₒ and an organic titanium salt of the formula XₘTiYₒ comprises potassium titanyl oxalate, and the catalyst enhancer comprises a soluble aluminum compound and potassium oxalate.

12. The method of claim 8, wherein the feedstock comprises a carboxylic acid and an alcohol, the condensation reaction comprising esterifying the carboxylic acid with the alcohol.

13. The method of claim 12, wherein the carboxylic acid comprises terephthalic acid, the alcohol comprises ethylene glycol, and the condensation product comprises BHET.

14. The method of claim 8, wherein the feedstock comprises BHET and the condensation product comprises PET.

15. The method of claim 8, wherein the feedstock consists essentially of PET, the heating being performed at a temperature below a melting point of the feedstock, the condensation product comprising PET of higher molecular weight than the PET in the feedstock.

16. An ester made by a method comprising performing an ester-forming condensation reaction on a feedstock, the reaction comprising heating a mixture of the feedstock and a catalyst composition comprising:
(a) one or both of a titanyl compound of the formula XₘTiOYₒ and an organic titanium salt of the formula XₘTiYₒ; and
(b) a catalyst enhancer comprising a compound selected from the group consisting of soluble compounds of Al, Co, Zn, and Sn;
wherein X is selected from the group consisting of: H, Li, Na, K, Rb, Cs, Be, Ca, Mg, Sr, Ba, and ammonium; m=0, 1 or 2; Y is a ligand of the formula CₐH_{b}O_{c} wherein a=1 to 30, b=0 to 60, and c=1 to 10; and o=2, 3, or 4.

17. A method of making an ester, the method comprising performing an ester-forming condensation reaction on a feedstock consisting essentially of PET to produce a condensation product comprising PET of higher molecular weight than the PET in the feedstock, the reaction comprising heating, at a temperature below a melting point of the feedstock, a mixture of the feedstock and a catalyst composition comprising:
(a) one or both of a titanyl compound of the formula XₘTiOYₒ and an organic titanium salt of the formula XₘTiYₒ; and
(b) a catalyst enhancer comprising a compound selected from the group consisting of oxalate or C₁-C₂₆ carboxylate salts of Li, Na, K, Rb, Cs, Be, Ca, Mg, Sr, and Ba,
wherein the catalyst enhancer comprises an oxalate salt if the catalyst composition comprises XₘTiYₒ;
wherein X is selected from the group consisting of: H, Li, Na, K, Rb, Cs, Be, Ca, Mg, Sr, Ba, and ammonium; m=0, 1 or 2; Y is a ligand of the formula CₐH_{b}O_{c} wherein a=1 to 30, b=0 to 60, and c=1 to 10; and o=2, 3, or 4.

18. The method of claim 17, wherein one or both of the catalyst and the enhancer comprises an oxalate moiety.

19. The method of claim 17, wherein the catalyst enhancer comprises a salt of potassium.

20. The method of claim 17, the catalyst composition further comprising a soluble antimony compound.

21. The method of claim 17, the catalyst composition further comprising a soluble germanium compound.

22. The method of claim 17, wherein said one or both of a titanyl compound of the formula XₘTiOYₒ and an organic titanium salt of the formula XₘTiYₒ comprises potassium titanyl oxalate, and the catalyst enhancer comprises potassium oxalate, the catalyst composition further comprising a soluble antimony compound.

23. An ester made by a method comprising performing an ester-forming condensation reaction on a feedstock consisting essentially of PET to produce a condensation product comprising PET of higher molecular weight than the PET in the feedstock, the reaction comprising heating, at a temperature below a melting point of the feedstock, a mixture of the feedstock and a catalyst composition comprising:
(a) one or both of a titanyl compound of the formula XₘTiOYₒ and an organic titanium salt of the formula XₘTiYₒ; and
(b) a catalyst enhancer comprising a compound selected from the group consisting of oxalate or C1-C₂₆ carboxylate salts of Li, Na, K, Rb, Cs, Be, Ca, Mg, Sr, and Ba,
wherein the catalyst enhancer comprises an oxalate salt if the catalyst composition comprises XₘTiYₒ;
wherein X is selected from the group consisting of: H, Li, Na, K, Rb, Cs, Be, Ca, Mg, Sr, Ba, and ammonium; m=0, 1 or 2; Y is a ligand of the formula CₐH_{b}O_{c} wherein a=1 to 30, b=0 to 60, and c=1 to 10; and o=2, 3, or 4.

24. The ester according to claim 23, wherein the catalyst composition further comprising a soluble antimony compound.

25. The ester according to claim 23, wherein the catalyst composition further comprising a soluble germanium compound.
